(19) United States
(12) Patent Application Publication
(10) Pub. No.: US 2007/0094078 A1
(43) Pub. Date: Apr. 26, 2007

(54) Internet shopping portal

(76) Inventor: Michael Elkaim, Brussels (BE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/582,053

(22) Filed: Oct. 16, 2006

Related U.S. Application Data
(60) Provisional application No. 60/726,713, filed on Oct. 14, 2005.

(51) Int. Cl. G06Q 30/00

(52) U.S. Cl. 705/14; 705/26

(57) ABSTRACT

An Internet shopping portal configured to present a user with a Internet shopping portal including a link to one of a number of possible online vendors of goods and services; and to reward the user for using the Internet shopping portal with an authorisation or credit which can be used to download video or audio media.

### RELATED APPLICATION

The present application is related to and claims priority from U.S. Provisional Application No. 60/726,713, filed Oct. 14, 2005, which is incorporated herein by reference in its entirety.

### FIELD OF INVENTION

This invention relates to a method and computer system employed by an Internet shopping portal.

### BACKGROUND TO INVENTION

An Internet shopping portal is a website through which a user of the Internet is able to browse for the purposes of being directed to one of a number of online goods or service providers.

Typically, the Internet shopping portal will provide a searchable directory of online goods and service providers that a user is able to choose from and be directed to with a hyperlink (either directly or indirectly). One of the best known examples of this type of Internet shopping portal is the shopping directory of Yahoo®, at the time of writing located at http://shopping.yahoo.com.

Other Internet shopping portals provide the user with the ability to search for goods and services and upon selection of one particular good or service, the Internet shopping portal presents the user with a link to a provider or links to providers of that good or service. In the case of the latter, such a list is often presented sorted by ascending price. An example of this type of directory would be Kelkoo® portal, at the time of writing located at http://www.kelkoo.co.uk.

One business model employed by such Internet shopping portals is to receive commission from online goods and service providers for user referrals whilst providing the Internet shopping portal service to the user for free. For example, a fix amount can be levied or a variable amount based on the value of any transaction that results from a user being referred to a particular online goods or services provider.

Alternatively or in addition, an Internet shopping portal may derive revenue from advertisers paying for screen space, e.g. advertising banners, or a preferred status in relation to the providers of goods and services presented to users, e.g. payment to be at the top of a list.

Affiliate Networks often act as an intermediary between Internet shopping portals and vendors. For example, a vendor may provide an inventory of products to the Affiliate Network which will then distribute this inventory to many Internet shopping portals. Such Affiliate Networks can also act conduits for payment between vendors and Internet shopping portals. Furthermore, it is possible for a single Internet shopping portal to use more than one Affiliate Network. Therefore, in the absence of a statement to the contrary, any reference hereafter to communication, payment etc. between Internet shopping portals and Vendors includes indirect such communication, payment etc. via Affiliate Networks.

### SUMMARY OF INVENTION

In accordance with the present invention, there is provided a method and an Internet shopping portal server implementing such a method, the method comprising the steps of: presenting a user with an Internet shopping portal including a link to one of a number of possible online vendors of goods and services; and rewarding the user for using the Internet shopping portal with an authorisation or credit which can be used to download video or audio media.

Such a reward may be payable only when the user followings the link to and enters in to a transaction with said one of a number of possible online vendors of goods and services.

Whilst the invention applies equally to any video and audio media in any format, the preferred reward is download authorisation codes for music tracks and/or albums, of part thereof which enable the user to download said music or to contribute to the cost of downloading said music from commercial music providers such as iTunes®, at the time of writing located at http://www.apple.com/uk/itunes.

By authorisation codes and credits, it is meant a code which will either enable a user to download a package of video or audio media (e.g. an audio track or album); or a credit with a nominal cash value which is redeemable against the whole cost or part of the cost of downloading such video or audio media.

The inventor has realised that because of the competitive market in which Internet shopping portals operate, it is desirable to reward users of an Internet shopping portal to engender loyalty and, hopefully, to increase either the number or users of that Internet shopping portal and/or the frequency of use by existing users of that Internet shopping portal; and an authorisation or credit to download third party media is particularly effective because of their attraction to a significant percentage of the type of users who use Internet shopping portals.

### BRIEF DESCRIPTION OF DRAWINGS

The present invention will now be described, by way of example only, with reference to the accompanying figures in which:

FIG. 1 is a schematic of an Internet network, depicting an Internet shopping portal server employing the present invention, a vendor server, a music download server and a user computer; and

FIG. 2 is a message sequence diagram illustrating the interaction between the servers and user computer of FIG. 1.

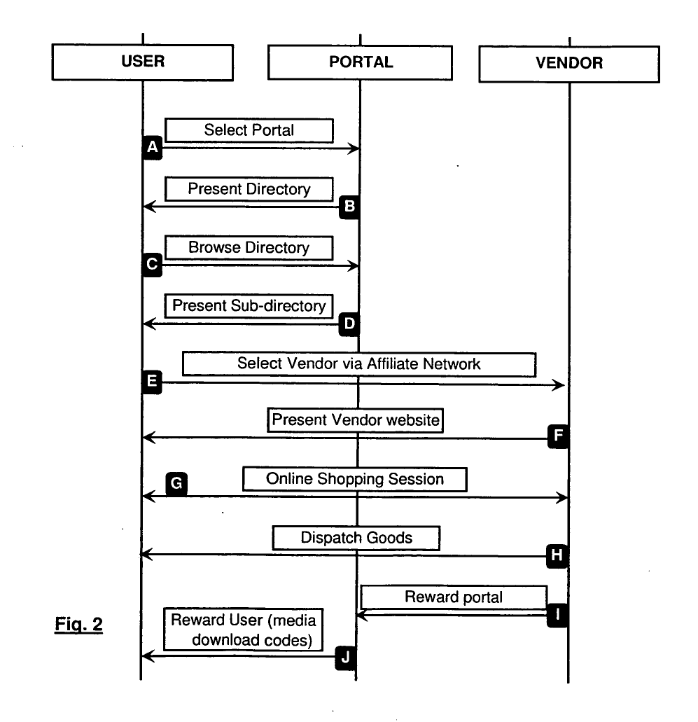

### DETAILED DESCRIPTION

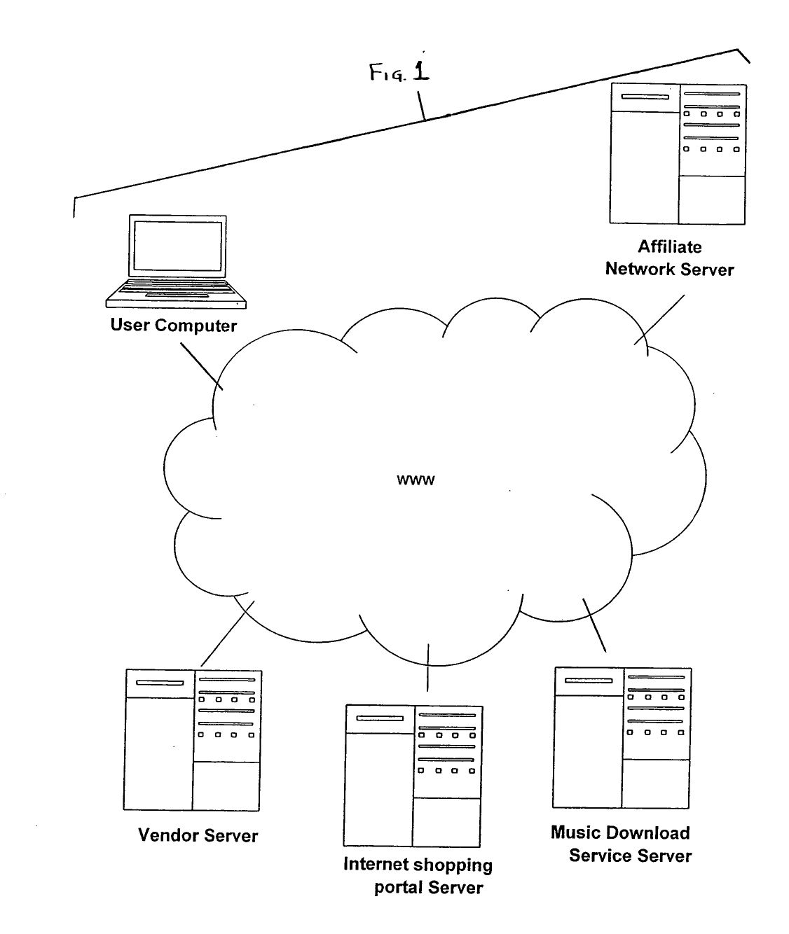

The computer of a user (“User Computer”) and servers of an online goods vendor (“Vendor Server”), an Affiliate Network (“Affiliate Network Server”), an Internal portal provider (“Internet shopping portal Server”) and a online music service provider (“Music Download Service Server”) are each depicted in FIG. 1 connected to the Internet.

The Music Download Server is one of a convention type as employed by current commercial online music providers and is configured to enable a user to enter a download code to access and download any particular music track; or to provide a credit redeemable against the whole cost or part of the cost of downloading such a music track.

The Basic Process

The scenario described below will illustrate the present invention from the starting point of a user initiating a session between the User Computer with the Internet shopping portal Server.

Prior to this, it is assumed that the provider of the Internet shopping portal has purchased from the provider of the music download server download codes which the provider of the Internet shopping portal is able to pass on to its users.

With reference to FIG. 1, Step A illustrates a User initiating a session with an Internet shopping portal by selecting on the User Computer the Internet shopping portal website address, e.g. by selecting a “favourite” previously bookmarked.

Uses are identified initially by a login and/or registration process but may be subsequently identified by a cookie or the like, thereby providing a seamless browsing experience. Identification can be also done retrospectively in that the details of a cookie downloaded to a User's computer after a first session between a User's computer and the Internet shopping portal can be matched to a login and/or registration process later.

As is conventional, step B, C and D illustrate a User browsing an Internet shopping portal's directories and subdirectories of vendors for the purpose of selecting a vendor from who the User wishes to make a purchase. Alternatively, a search for a vendor may be done by a search engine responsive to key words, such key words being directed to either the vendor or the goods or services sold by the vendor.

As illustrated in step E, a user selects a particular vendor from the vendor directory by selecting a hyperlink directed to the Affiliate Network and identifying the chosen vendor (by Affiliate Network's vendor codes) and/or vendor webpage (again by the Affiliate Network's codes), the referring Internet shopping portal and the Internet shopping portals' User and referral reference. As the use of Affiliate Networks is conventional, it is not described herein in any further detail.

Thereafter, as illustrated in steps F and G, the User and the Vendor engage in an online shopping session results in the User purchasing certain goods and, in step H, the Vendor dispatching certain goods. As this process is conventional, it is not described herein in any further detail.

For the referral, the Vendor pays a commission to the Internet shopping portal provider via the Affiliate Network as shown in step I. The Internet shopping portal is able to map the details of the Vendor transaction (and hence the commission due) by matching the Internet shopping portals' User and referral reference in its database records with that returned by the Affiliate Network. In practice, the Internet shopping portal will process Vendor transaction/commission reports in a batch, say every few hours. The corresponding cash transactions (i.e. reimbursement of the commission to from the Vendor via the Network Affiliate to the Internet shopping portal are processed less regularly.

Thereafter, as illustrated in step K and in accordance with the present invention, the Internet shopping portal rewards the User for using the Internet shopping portal with music download codes originally provided by the Music Download Service's Server. The User can collect them after logging on to the Internet shopping portal.

With the music download codes, the user is then able to download music from the Media Download Server of a commercial music service provider using the music download codes. As this process is conventional, it is not described herein in any further detail.

Earning Music Download Codes

The amount of music download codes (or any other authorisations or credit for media download) can be based on the amount of the Vendor's sale and/or the Internet shopping portals commission.

The rate of commission may vary from vendor to vendor. Hence, it is desirable to present the user with the rate and/or terms at which authorisations or credit for media download are earned for any given vendor. If two vendors sell the same product at the same price, the rate of media reward may well be a factor in determining which vendor a user chooses. Indeed, it would be convenient for the user if the vendors would be searched on this basis.

It is convenient if the Internet shopping portal provides a mechanism by which a user is able to check the total number of music download codes/credit and also a breakdown based on specific vendors, e.g. a “my account” page for the User at the Internal portal website.

As described above, the Internet shopping portal rewards the User with download codes after the corresponding reward to the Internet shopping portal from the vendor has been confirmed. In the meantime, such rewards can be presented to the User as having a pending status where they are not immediately redeemable. Alternatively, the User may be provided with immediate rewards, discounting the possibility of the Vendor transaction being repudiated. This would be a service that the Internet shopping portal could charge the User for, e.g. by paying a 5$ charge or depositing 5$ on account, a user may be able to receive up to 100 download codes that would otherwise be pending.

It may be possible for the Internet shopping portal to charge the User for a preferential rate at which the User earns music download codes.

Recommendations/Redirection to Use the Internet Shopping Portal

It is contemplated that a user of the Internet shopping portal can maximise their earnings of music download codes by inviting other Users to use the Internet shopping portal. For example, if one User recommends the Internet shopping portal to a friend, that User could receive a one-time bundle of music download codes or, alternatively, a percentage of the future earnings of the User to whom the Internet shopping portal was referred.

This could be effected in several different ways. A new user could inform the Internet shopping portal of the existing User who referred that new user to the Internet shopping portal upon registration.

Alternatively, suppose a user submitted the email address(es) of prospective new users to the Internet shopping portal, subsequent emails from the Internet shopping portal to that prospective new user could include hyperlinks for the purpose of registration of that new user which identify the referring User. Such submission by a referrer of an email address could be accompanied with a personal message which may be appended to the email sent by the Internet shopping portal.

Whilst the above arrangements deal well with referrals from friends, it is also as envisaged that referral to the Internet shopping portal may simply comprise a link on a third party website (e.g. a banner or even a bare link in a newsgroup thread). A potential user may then be redirected to the Internet shopping portal with the entity providing the link identified by text in the hyperlink. It is also conceivable that the referring link could be published in other forms including print media. Such a link may be automatically provided to a prospective referrer upon an appropriate request being made to the Internet shopping portals website.

It would also be desirable for a user to be able to access from the Internet shopping portal information indicating the amount of music download credits earned through the Internet shopping portals invitation program.

Customisable GUI

The Internet shopping portal may have a dynamic interface facilitating prominent presentation of favourite vendors as selected by a user, vendors of a preferred genre, recently used and/or visited vendors, most used vendors etc. For example, a user might create their own customized interface by selecting a “my portal” option which will take them to a page that lists all vendor sites with a check box next to every one. The user can then run down the list of vendors and check every site they wish to add to the interface presented to that user.

The invention is described in the context of a User Computer and Servers connected across the Internet, however, it will be appreciated that the invention will be equally applicable to other WANs, LANs or other type of network.

From reading the present disclosure, other modifications will be apparent to persons skilled in the art. Such modifications may involve other features which are already known in the design and use of computer systems and component parts thereof and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation of one or more of those features which would be obvious to persons skilled in the art, whether or not it relates to the same invention as presently claimed in any claim and whether or not it mitigates any or all of the same problems as does the present invention. The applicants hereby give notice that new claims may be formulated to such features and/or combinations of such features during the prosecution of the present application or of any further application derived there from.

1. A method of operating an Internet shopping portal website comprising the steps of:
presenting a user with a Internet shopping portal including a link to one of a number of possible online vendors of goods and services; and
rewarding the user for using the Internet shopping portal with an authorisation or credit which can be used to download video or audio media.

2. A method according to claim 1 wherein such a reward may be payable only when the user followings the link to and enters in to a transaction with said one of a number of possible online vendors of goods and services.

3. A method according to claim 1 wherein the user was initially referred to the Internet shopping portal by a referrer; the method further comprising the step of rewarding the referral for the user using the Internet shopping portal with an authorisation or credit which can be used to download video or audio media.

4. A method according to claim 1 further comprising the step of presenting to the user of the Internet shopping portal, adjacent the link to one of a number of possible online vendors of goods and services, the rate at which the user can earn from the vendor authorisation or credit which can be used to download video or audio media.

5. An Internet shopping portal server configured to execute a method according to claim 1.
